(19) United States
(12) Patent Application Publication
(10) Pub. No.: US 2005/0201719 A1
(43) Pub. Date: Sep. 15, 2005

(54) Apparatus and method for executing contents reproducing program

(75) Inventors: Jeon Do Kang, Daejeon-si (KR); Jun Hyung Park, Anyang-si (KR)

Correspondence Address: FLESHNER & KIM, LLP, P.O. BOX 221200, CHANTILLY, VA, 20153, US

(73) Assignee: LG ELECTRONICS INC.

(21) Appl. No.: 11/028,554

(22) Filed: Jan. 5, 2005

(30) Foreign Application Priority Data
Mar. 15, 2004 (KR) 17250/2004

(51) Int. Cl. H04N 5/76; H04N 5/781

(52) U.S. Cl. 386/46; 386/125

(57) ABSTRACT

Embodiments of an apparatus for executing a contents reproducing program in computer and a method thereof can copy contents stored in a storage medium, store copied contents to a main memory and interrupt electric power to the storage medium during reproducing the contents stored in the main memory. Therefore, the apparatus and the method can increase efficiency of electric power usage, reduce noise or reduce heat generated from the storage medium.

### BACKGROUND OF THE INVENTION

1. Field of the Invention

The present invention relates to an apparatus for executing a contents reproducing multimedia in a computer, and a method thereof.

2. Background of the Related Art

It has become common to download multimedia contents including audio or video data to a hard disk of a computer through the Internet and to reproduce the audio or the video data of the downloaded contents whenever a user wants to listen to music or watch moving pictures by using a contents reproducing program. Generally, the contents reproducing program is a software program reproducing the audio and video data to play a music or the moving pictures in the computer. The contents reproducing program is common called as a multimedia player.

The development of information technology makes it possible to store the multimedia contents into a storage medium such as an optical magnetic disk or a memory card and to reproduce audio or video files included in the multimedia contents by using the computer. A windows media player is representative one of multimedia players reproducing the audio or video data included in the multimedia contents being used in the computer.

The windows media player is an application program that reproduces various types of audio and video data included in the multimedia contents. Also, there have been a number of multimedia players introduced besides the windows media player. Some of the multimedia players have a capability of reproducing only audio files and others have a capability of reproducing audio and video files.

The above described multimedia players play music or moving pictures by reading audio or video files included multimedia contents selected by the user among multimedia contents stored in a storage medium such as a hard disk, an optical disk and a memory card. Accordingly, the user can enjoy music or moving pictures by reproducing the audio or video files included in the multimedia contents stored in the storage medium.

However, as described above the related art apparatus and method for reproducing multimedia contents in a computer have various disadvantages. For example, the storage medium needs to be continuously driven for reading target multimedia contents from the storage medium while the multimedia player reproduces the target multimedia contents stored in the storage medium. Therefore, electric power is wasted for driving the storage medium during reproduction of the multimedia contents. Further, for a portable computer, such as a notebook computer, having limited capacity of electric power for reproducing the multimedia contents, the user may have difficulty caused by inefficient use of the limited electric power. Also, the storage medium may generate noise while the storage medium is driven. Such a noise may disturb the user and reduce the enjoyment of watching or listening to reproduced multimedia contents. In addition, a cooling fan may be also driven for cooling down heat generated from the storage medium while the storage medium is driven, and thus, a noise problem may get more serious by noise generated from the cooling fan.

The above references are incorporated by reference herein where appropriate for appropriate teachings of additional or alternative details, features and/or technical background.

### SUMMARY OF THE INVENTION

An object of the invention is to solve at least the above problems and/or disadvantages and/or to provide at least the advantages described hereinafter.

Another object of the present invention is to provide an apparatus for executing a contents reproducing program and a method thereof that substantially obviates one or more problems due to limitations or disadvantages of the related art.

Another object of the present invention is to provide an apparatus executing a contents reproducing program and a method thereof that disables a storage medium during reproduction of contents stored thereon.

Another object of the present invention is to provide an apparatus executing a contents reproducing program and a method thereof for increasing efficiency of using electric power, reducing noise, or reducing heat generated from a storage medium by interrupting the storage medium during reproducing the multimedia contents.

To achieve at least the above objects or other advantages in a whole or in part and in accordance with the purpose of the invention, as embodied and broadly described herein, there is provided an apparatus for executing a content reproducing program in a computer, the apparatus includes a storage medium configured to store a plurality of first contents, a main memory configured to temporally store a second content selected from the first contents by a predetermined condition and a controller configured to selectively interrupt electric power to the storage medium during reproduction of the second content stored in the main memory.

To further achieve at least the above objects or other advantages in a whole or in part and in accordance with the purpose of the invention, as embodied and broadly described herein, there is provided a method for operating a portable computer, the method includes executing a contents reproducing program according to a request from a user, selecting one of contents stored in a storage medium, storing the selected content in a main memory, reproducing the selected content stored in the main memory and interrupting electric power supplied to the storage medium.

To further achieve at least the above objects or other advantages in a whole or in part and in accordance with the purpose of the invention, as embodied and broadly described herein, there is provided a method that includes executing a contents reproducing program to reproduce selected contents stored in a storage medium and determining to perform a power control mode for the contents reproduction program responsive to a predetermined condition, wherein the power control mode interrupts the power supplied to the storage medium when the selected contents are being reproduced.

Additional advantages, objects, and features of the invention will be set forth in part in the description which follows and in part will become apparent to those having ordinary skill in the art upon examination of the following or may be learned from practice of the invention. The objects and advantages of the invention may be realized and attained as particularly pointed out in the appended claims.

### BRIEF DESCRIPTION OF THE DRAWINGS

The invention will be described in detail with reference to the following drawings in which like reference numerals refer to like elements wherein:

FIG. 1 is a diagram illustrating a user interface of a windows media player;

FIG. 2 is a diagram showing a preferred embodiment of a computer according to the present invention;

FIG. 3 is a diagram depicting an exemplary main memory having a basic memory area and an extended memory area for use in the computer of FIG. 2;

FIG. 4 is a diagram illustrating an exemplary switching circuit between a keyboard controller and a storage medium in accordance with a preferred embodiment of the present invention;

FIG. 5 is a diagram depicting an embodiment of switching circuit selectively interrupting electric power supplied to a hard disk based on the keyboard controller in accordance with the present invention; and

FIGS. 6 to 10 are flowcharts showing preferred embodiments of methods for reproducing multimedia contents in accordance with the present invention.

### DETAILED DESCRIPTION OF PREFERRED EMBODIMENTS

Apparatus for executing a contents reproducing program and methods thereof in accordance with embodiments of the present invention can be implemented in various types of computers such as a desktop computer or a notebook computer. Embodiments of apparatus for reproducing multimedia contents and methods thereof can copy multimedia contents stored in the storage medium, temporarily store the copied multimedia contents in the main memory and interrupt supplied electric power to the storage medium during reproducing the multimedia contents stored in the main memory.

Embodiments according to the present invention can give better efficiency (e.g., longer battery life) when implemented in devices such as a notebook computer or the like, having limited electric power capacity. The storage medium can be a storage device including a hard disk, an optical disk, a memory stick or the like, which is distinguished from the main memory.

The main memory is not included in the storage medium. The main memory can be a memory equipped in a main board of the computer, and the storage medium is a storage device electrically coupled to the main memory for storing data.

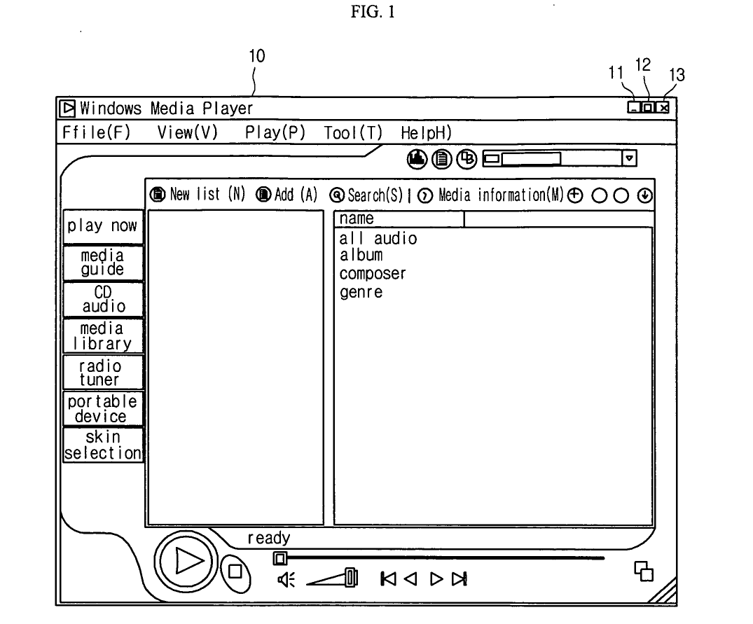

FIG. 1 is a diagram illustrating a user interface of a contents reproducing program (e.g., windows media player) where embodiments according to the present invention can be implemented. As a contents reproducing program, the windows media player is an application program that reproduces various types audio and video files included in multimedia contents.

The windows media player is an exemplary representative one of the contents reproducing programs. As described above, the contents reproducing program can be a software program reproducing the audio and video files to play music or moving pictures in the computer or the like. The contents reproducing program is commonly called a multimedia player. The windows media player is used as an example for describing embodiments according to the present invention, however the embodiments are not intended to be so limited and can be implemented to any other multimedia players.

As shown in FIG. 1, a user interface 10 of the windows media player can include three buttons 11, 12, 13 at upper right corner of the user interface for closing, reducing and enlarging the user interface 10 of the windows media player. When a user clicks the minimizing button 11, the user interface 10 is minimized on to a task bar.

When the maximizing button 12 is clicked, the user interface 10 is maximized to occupy entire screen of a displayer. The user interface 10 is closed and the windows media player is terminated when the closing button 12 is activated.

In one embodiment according to the present invention, the maximizing or enlarging of the user interface 10 may activate a power control mode for interrupting to supply electric power to the storage medium.

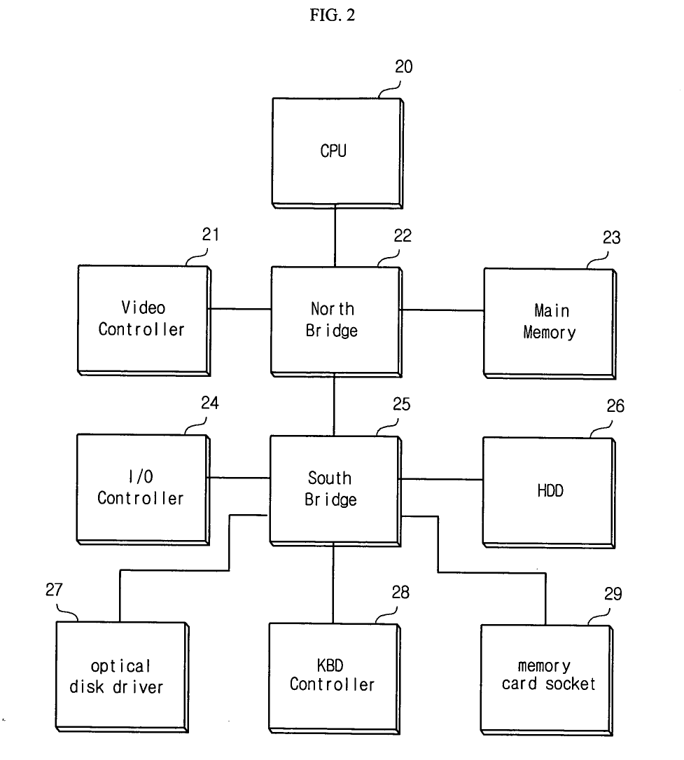

FIG. 2 is a diagram showing an embodiment of computer according to the present invention. As shown in FIG. 2, the computer can include a central processing unit (CPU) 20, a video controller 21, a North Bridge 22, a main memory 23, an Input/Output (I/O) controller 24, a South Bridge 25, a hard disk driver (HDD) 26 and a KBD controller 28.

The computer can further include an optical disk driver 27 and a memory card socket 29 for reading and writing data from/to a storage medium detachable from the computer such as an optical disk and a memory card. The main memory 23 can include a basic memory area and an extended memory area.

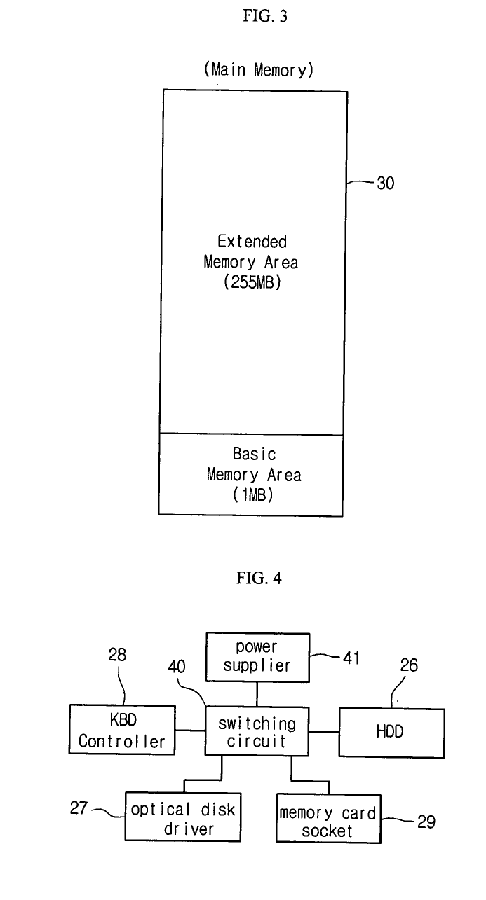

As shown in FIG. 3, for example, in case of an exemplary main memory 30 as the main memory 23 having 256 Mbytes as storage capacity, the main memory 30 may be divided to 1 Mbytes of the basic memory area and 255 Mbytes of the extended memory area. However, the present invention is not intended to be so limited.

For example, the basic memory area can be divided and allocated to an interrupt vector table, a ROM bias data area, a dos data area, a user area and a system ROM bias for storing essential data. The extended memory area (e.g., 255 MB) can be divided and allocated for storing common data.

Embodiments of a multimedia player of the present invention can copy the multimedia contents stored in the hard disk 26, stored in the optical disk inserted in the optical disk driver 27 or the memory card inserted in the memory card socket 29 to the main memory 30 (e.g., extended memory area). After copying the multimedia contents to the extended memory area of the main memory 30, the multimedia player can reproduce the multimedia contents by reading the multimedia contents stored in the extended memory area of the main memory 30.

In case of a size of the multimedia contents are larger than the extended memory area, the multimedia contents may be divided into a plurality of divided files. Then, the divided files can be temporally stored and reproduced (e.g., in a prescribed order).

For example, if the size of the multimedia contents is 400 Mbytes, the multimedia player may copy 200 Mbytes of the multimedia contents, temporarily store the copied multimedia contents into the main memory, and then play the copied multimedia contents first. After reproducing the copied multimedia contents, the multimedia player can reproduce the remaining multimedia contents by copying the remaining 200 Mbytes of the multimedia contents stored in the storage medium and storing the remaining multimedia contents into the main memory.

In a meantime, a controller (e.g., the keyboard controller 28) can generate a control signal and output the generated control signal for controlling (e.g., interrupting) supply of unnecessary electric power to the storage medium such as the hard disk 26, the optical disk driver 27 and the memory card socket 29. As shown in FIG. 4, the keyboard controller 28 can be coupled to a switching circuit 40 and cut off a connection between the power supplier 41 and the hard disk 26, the optical disk driver 27 or the memory card socket 29 according to the control signal.

For example, the keyboard controller 28 can stop supplying electric power to the hard disk 28 when the multimedia player copies the multimedia contents stored in the hard disk 26 and temporally stores the copied multimedia contents in the main memory. Further, the keyboard controller 28 can interrupt electric power supply to the optical disk driver 27 when the multimedia player copies the multimedia contents stored in the optical disk driver 27 and temporally stores the copied multimedia contents in the main memory.

Moreover, the keyboard controller 28 can stop supplying electric power to the memory card socket 29 when the multimedia player copies the multimedia contents stored in the memory card and temporally stores the copied multimedia contents in the main memory.

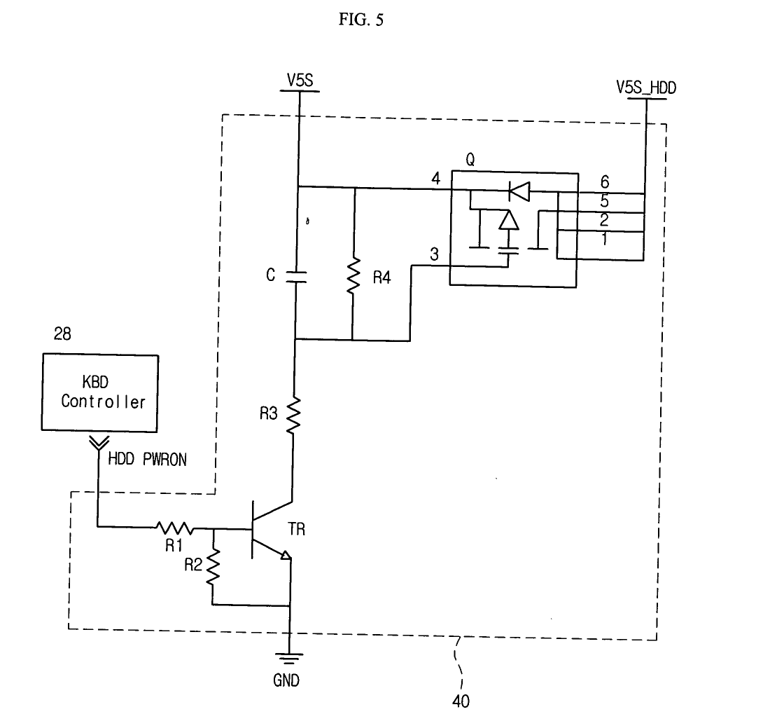

FIG. 5 is diagram illustrating an embodiment of switching circuit according to the present invention. As shown in FIG. 5, a switching circuit 50 can be between the keyboard controller 28 and the hard disk 26. However, the present invention is not intended to be so limited. For example, the switching circuit 50 can be used by a chip set of the south bridge 25 or an additional circuit may be used in implementing the switching circuit 50. Further, other storage mediums such as the optical disk driver 27 can replace the hard disk 26.

As shown in FIG. 5, the computer can include the switching circuit 50 having a transistor (R) configured to be on/off according to a control signal (e.g., HDD PWRON) outputted from the keyboard controller 28. For example, the keyboard controller 28 may be programmed for generating and outputting a control signal through a general purpose input/output (GPIO) pin.

As shown in FIG. 5, when the transistor (TR) is turned on, electric power of the hard disk (e.g., V5S_HDD) can be cut off When the transistor (R) is turned off, electric power can be supplied to the hard disk.

For example, when the multimedia player reproduce multimedia contents stored in the main memory, the keyboard controller 28 can output a control signal of a high pulse for turning the transistor (TR) on and the electric power of the hard disk (e.g., V5S_HDD) can be cut off By interrupting the electric power to the hard disk, efficiency of using electric power can be improved, or noise and heat generated from the hard disk can be eliminated.

Operations of cutting off the electric power supplied to the storage medium may be determined according to state of electric power usage in the computer such as a battery mode or an AC mode. However, the present invention is not intended to be so limited.

The battery mode can be considered a state of electric device using electric power from preinstalled battery without receiving electric power from external. For example, the notebook computer is in the battery mode when the notebook computer is driven by using electric power from the battery. The AC mode can be considered a state of the electric device using the externally supplied electric power. When embodiments according to the present invention are implemented into the notebook computer, it can demonstrate better efficiency than implementation into the desktop computer.

Further, the electric power may be controlled to supply to the storage medium based on activation of the multimedia player. For example, the electric power may be interrupted to supply to the storage medium only when the user interface of the multimedia player is maximized to occupy the entire screen of a displayer, the “maximize button” has been activated or the like.

Also, when the size of the multimedia contents selected by the user is larger than the size of extended memory area in the main memory, the multimedia contents may be divided into a plurality of divided files. The multimedia contents are then preferably reproduced by orderly storing the divided files to the main memory.

When the multimedia player completes playing a current divided file stored in the main memory, the storage medium can be re-driven by supplying the electric power again and the multimedia player can copy a next divided file into the main memory. Thus, the multimedia contents stored in the storage medium can be continuously played.

Preferably, the video controller 21 may detect a remaining time for playing the divided file stored in the main memory or remained file size of the divided file stored in the main memory for driving the storage device (e.g., hard device) at a prescribed time. For example, the electric power of the storage medium can be re-supplied for copying next divided file stored in the hard disk before completing performance of a divided file stored in the main memory to continuously play the multimedia contents. After completing storage of the next divided file in the main memory, the electric power of the hard disk can be cut off again.

As described above, according to one embodiment the multimedia contents stored in the hard disk can be continuously played by re-supplying electric power to the storage medium for copying and storing additional divided files into the main memory before completion of the divided file stored in the main memory area.

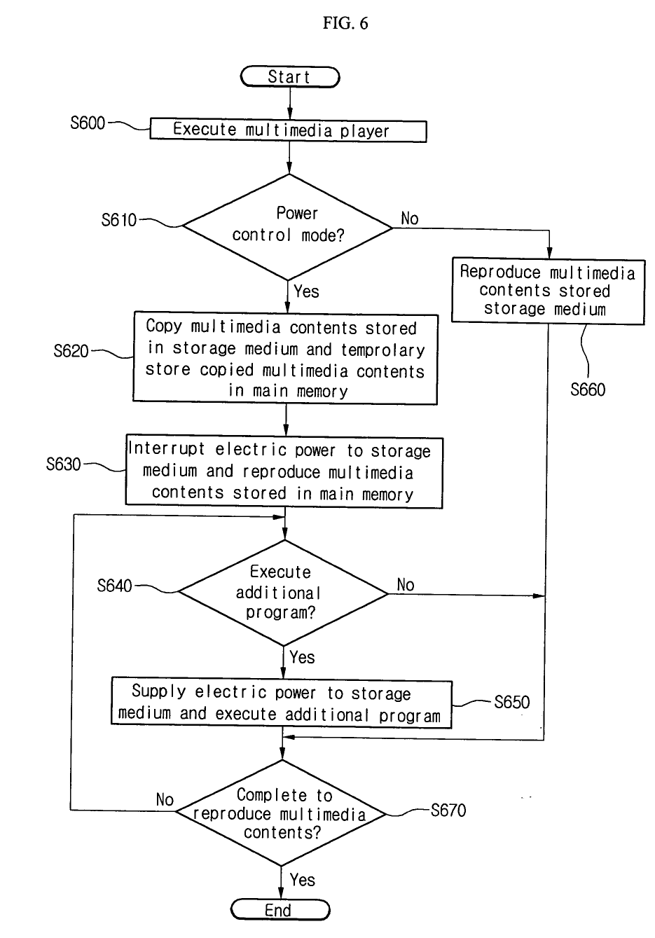

Embodiments of methods for reproducing the multimedia contents by interrupting to supply electric power to storage medium is illustrated in FIGS. 6 to 10. FIGS. 6 to 8 are flowcharts showing embodiments of methods for reproducing multimedia contents in accordance with the present invention. As shown in FIGS. 6-8, methods for reproducing multimedia contents will be described using and can be applied to the apparatus of FIG. 4. However, the present invention is not intended to be so limited.

As shown in FIG. 6, a user can execute a contents reproduction device (e.g., a multimedia player) in a computer at step S600. The multimedia player can be a software program reproducing audio and video files included in the multimedia contents to play music or a moving pictures in the computer. The multimedia player may play only audio files or play both of audio and video files.

The user can determine whether a power control mode is performed at step S610. The power control mode is preferably a mode of controlling electric power supply to the storage medium.

For example, when the user sets the power control mode, electric power is supplied to the storage medium when selected multimedia contents stored in the storage medium are copied to the main memory. Further, electric power can be interrupted for supplying to the storage medium after completing the copy of the selected multimedia contents to the main memory.

As shown in FIG. 6, the power control mode may be set to perform one time, whenever required, repeatedly performed, or may be set to continuously perform using an initial or updated setting. However, the power control mode can be performed only when the storage medium is not essentially required to be driven. For example, the power control mode is preferably halted during execution of operations that require driving of the storage medium.

After performing the power control mode, the multimedia contents stored in the storage medium can be copied and stored in the main memory at step S620. After storing the multimedia contents in the main memory, electric power supplied to the storage medium is interrupted, and the multimedia contents stored in the main memory are reproduced at step S630.

When an additional program requiring driving of the storage medium is required to be executed during performing the power control mode, electric power can be supplied to the storage medium and the additional program is executed at steps S640 and S650, respectively.

If the user sets the power control mode off, the multimedia contents stored in the storage medium can be reproduced by driving the storage medium at step S660. After completing to play the multimedia contents stored in the main memory, the power control mode can be continuously performed or terminated according to operations executed in the computer at step S670.

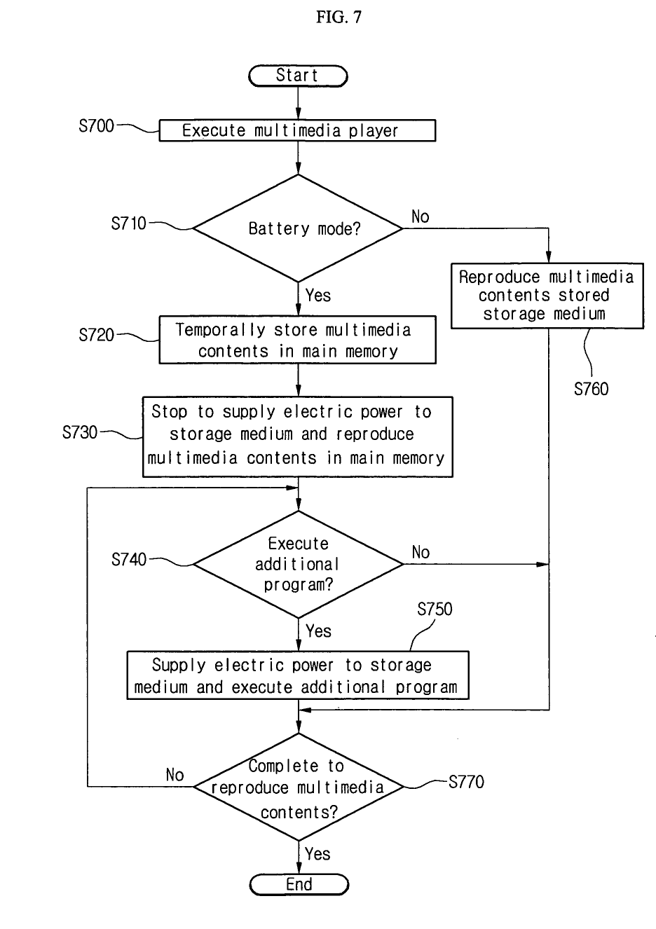

FIG. 7 is a flowchart showing a method for reproducing multimedia contents in accordance with another embodiment of the present invention. FIG. 7 shows a method reproducing multimedia contents for a notebook computer or the like in accordance with the present invention.

As shown in FIG. 7, a user can load a multimedia player at step S700. The multimedia player can determine whether electric power is externally supplied at step S710.

If there is no electric power supplied from external then a computer is operated by using electric power supplied from a battery (e.g., battery mode). Therefore, a power control mode can be performed for operation in battery mode.

For example, multimedia contents stored in the hard disk can be copied and temporally stored in the main memory at step S720. The stored contents can be reproduced at step S730.

When an additional program requiring driving of the storage medium is required to be performed during performing the power control mode, electric power can be supplied to the storage medium and the additional program is loaded at steps S740 and S750, respectively.

If it is determined that the computer is not in battery mode (step S710), the multimedia player can reproduce the multimedia contents by orderly reading the multimedia contents stored in the storage medium at step S760. After completing to play the multimedia contents stored in the main memory, the power control mode can be continuously performed or stopped according to operations of programs performed in the computer at step S770. The embodiment depicted in FIG. 7 increases efficient use of electric power.

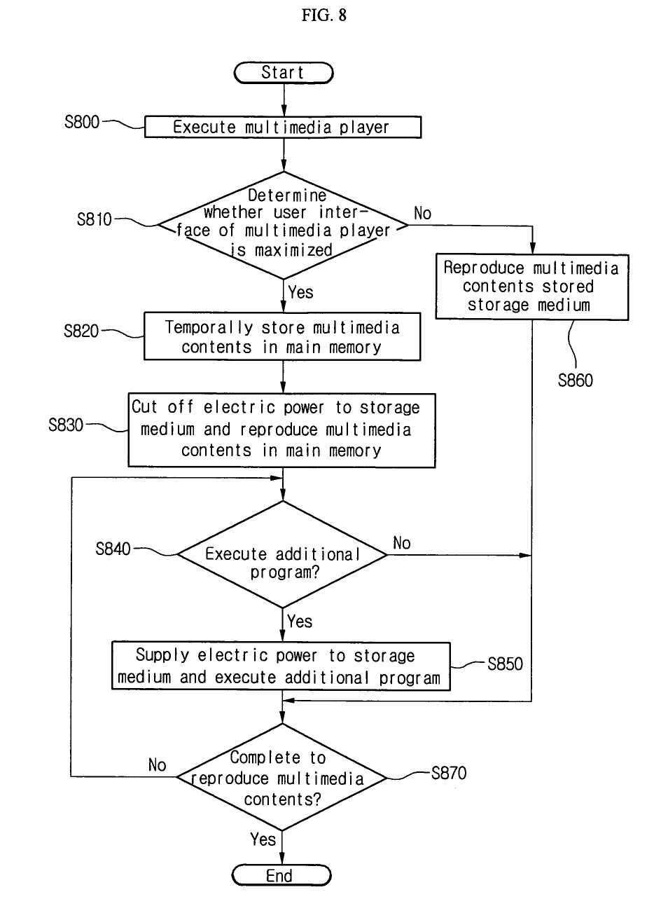

FIG. 8 is a flowchart showing a method for reproducing multimedia contents in accordance with another embodiment of the present invention. As shown in to FIG. 8, a user can perform a multimedia player at step S800.

The multimedia player can determine whether a user interface (e.g., window) of the multimedia player is selected (e.g., maximized) at step S810. When the user interface of the multimedia player is maximized, the user interface can occupy an entire screen of a displayer.

When the user interface of the multimedia player is maximized, the user does not execute additional programs generally. For example, the user usually maximizes the user interface of the multimedia player when the user plays moving pictures by using the multimedia player. Alternatively, the multimedia player can determine whether additional application programs are operating.

If the user interface of the multimedia player is maximized, a power control mode can be activated at step S810. For example, multimedia contents stored in the hard disk can be copied and temporally stored in the main memory and stored contents can be reproduced after cutting off electric power supplied to the hard disk at step S820 and S830, respectively.

When an additional program requiring driving of the storage medium is required to be executed during performing the power control mode, electric power can be supplied to the storage medium at step S840. The additional program can be loaded at step S850.

However, if it is determined that the user interface is not maximized at step S810, the multimedia player can reproduce the multimedia contents by ordering reading the multimedia contents stored in the storage medium at step S860. After completing to play the contents stored in the main memory, the power control mode can be continuously performed or stopped according to operations of programs performed in the computer at step S870.

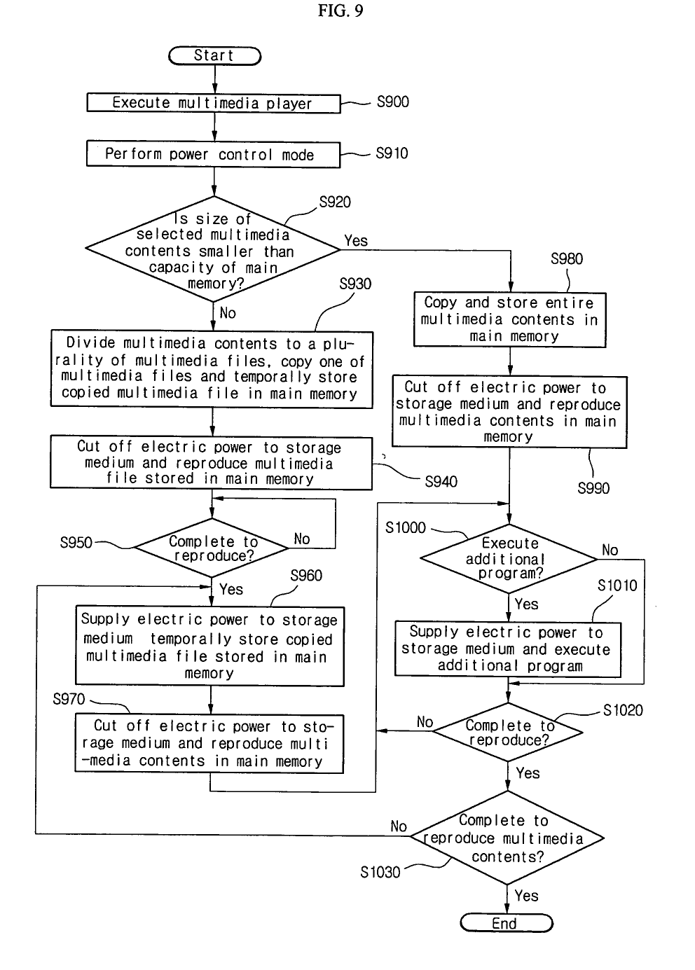

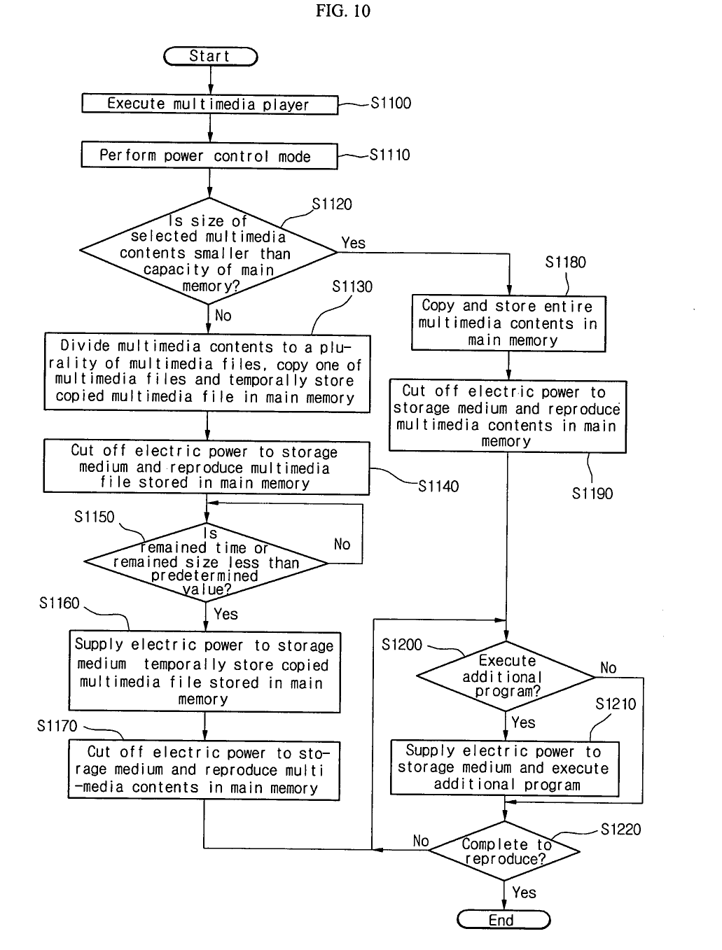

FIGS. 9 and 10 are flowcharts showing embodiments of methods for reproducing multimedia contents in accordance with the present invention. Methods in FIGS. 9 and 10 can control electric power supplied to a storage medium according to a size of the multimedia contents.

As shown in FIG. 9-10, embodiments of methods for reproducing multimedia contents will be described using and can be applied to the apparatus of FIG. 4. However, the present invention is not intended to be so limited.

As shown in FIG. 9, a user can execute a multimedia player at step S900. A power control mode can be performed at step S910.

For example, performance of the power control mode may be determined according to various conditions in accordance with embodiments described in FIGS. 6 to 8. However, the present invention is not intended to be so limited.

The multimedia player can determine whether it is possible to store selected multimedia contents to a main memory at step S920.

When a size of the selected multimedia contents is larger than a capacity of the main memory, the selected multimedia contents can be divided to a plurality of multimedia files. Then, the plurality of multimedia files can be performed in sequence by intermittently interrupting and re-supplying power to the storage medium. One of multimedia files can be copied and stored in the main memory according to an order of reproducing the selected multimedia contents at step S930.

Electric power supplied to the storage medium can be interrupted and the multimedia file stored in the main memory can be reproduced at step S940. After cutting off the electric power to the storage medium, if additional program requiring driving of the storage medium is required to be executed, the electric power can be supplied to the storage medium and the additional program can be loaded (e.g., steps S1000 and S1010).

After completing playing the multimedia file stored in the main memory at step S950, then, the electric power can be supplied to the storage medium again and next multimedia file stored in the storage medium can be copied and stored in the main memory according to the order of reproducing the multimedia contents at step S960. After storing, electric power is supplied to the storage medium can be interrupted and the next multimedia file stored in the main memory is reproduced at step S970.

The above described operations for dividing the oversized multimedia contents to a plurality of multimedia files, orderly copying and storing multimedia files in the main memory may be repeatedly performed according to the size of multimedia contents and a capacity of the main memory. Further, the determination in step S950 can be made such that continuous reproduction of the multimedia contents is performed.

If the size of the multimedia contents is smaller than the capacity of the main memory, the multimedia player can copy and store entire multimedia contents stored in the storage medium to the main memory at step S980. The electric power supplied to the storage medium can be interrupted, and the multimedia player can reproduce the multimedia contents stored in the main memory at step S990.

In a meantime, when additional program requiring driving of the storage medium is required to be executed during performing the power control mode, electric power can be supplied to the storage medium and the additional program can be loaded at steps S1000 and S1010. It can be determined if the multimedia file stored in the main memory has been completely reproduced at step S1020.

After completing playing the multimedia file stored in the main memory (e.g., next multimedia file) at step S1020, it can be determined if all multimedia files of the multimedia contents have been played. After completing to play the multimedia contents stored in the main memory, the power control mode is continuously performed or stopped according to operations of programs performed in the computer at step S1030.

The embodiment of the method for reproducing multimedia contents shown in FIG. 10 will now be described. A multimedia player can be executed and a power control mode can be performed at steps S1100 and S1110. Performance of the power control mode may be determined according various conditions as described in FIGS. 6 to 8. However, the present invention is not intended to be so limited.

The multimedia player can determine whether it is possible to store selected multimedia contents to a main memory at step S1120.

When a size of the selected multimedia contents is larger than a capacity of the main memory, the selected multimedia contents can be divided to a plurality of multimedia files. One of multimedia files can be copied and stored in the main memory according to an order of reproducing the selected multimedia contents at step S1130.

Electric power supplied to the storage medium can be interrupted and the multimedia file stored in the main memory can be reproduced at step S1140. After interrupting the electric power to the storage medium, if additional program requiring driving of the storage medium is required to be executed, the electric power can be supplied to the storage medium and the additional program can be loaded at steps S1200 and S1210.

The above described operations for dividing the oversized multimedia contents to a plurality of multimedia files, orderly copying and storing multimedia files in the main memory while interrupting power supply to the storage medium may be repeatedly performed according to the size of multimedia contents and a capacity of the main memory. Further, the reproduction from the main memory can be monitored that continuous reproduction of the multimedia contents is performed.

The multimedia player can determine a remained time for reproducing the part of multimedia contents stored in the main memory or a remained size of the multimedia file stored in the main memory during reproducing the multimedia file stored in the main memory. After determining the remained time or the remained size, the multimedia player can compare the remained time or the remained size with a predetermined value at step S1150.

If the remained time or the remained size is less than the predetermined value, it means that the multimedia file stored in the main memory is almost completely reproduced.

Therefore, a remaining part of multimedia contents stored in the storage medium can be copied and stored to the main memory by supplying the electric power to the storage medium again, determining a size of the remained part of the multimedia contents stored in the storage medium, and copying and storing the remained part of the content stored in the storage medium to the main memory when there is enough space for storing the remained part of the multimedia content stored in the storage medium at step S1160.

For example, assuming that there is 250 Mbytes of available space in the main memory, the size of the remained part of the multimedia content stored in the storage medium is 210 Mbytes and it may set to copy 200 Mbytes of multimedia contents stored in the storage medium to the main memory. According to the above assumptions, the multimedia player can copy and store 200 Mbytes of the multimedia contents stored in the storage medium into the main memory first and 10 Mbytes of the multimedia contents are remained in the storage medium. During reproducing the multimedia contents, the multimedia player can determine available size of the main memory and if the available size of the main memory is 50 Mbytes, 10 Mbytes of the remained contents stored in the storage medium can be copied and stored in the main memory.

By determining available size of the main memory during the reproducing the multimedia contents and copying the remained part of the multimedia contents to the main memory, it does not requiring to re-supplying electric power to the storage medium for copying 10 Mbytes of the remained part of the multimedia contents after reproducing 200 Mbytes of multimedia contents stored in the main memory.

After storing, the next multimedia file stored in the main memory can be reproduced at step S1170.

On the contrary, if the size of the content file is smaller than the capacity of the main memory, the multimedia player can copy an entire content file stored in the storage medium to the main memory at step S1180. The electric power supplied to the storage medium can be cut off and the multimedia player reproduces the multimedia contents stored in the main memory at step S1190.

When additional program requiring driving of the storage medium is required to be executed during performing the power control mode, electric power can be supplied to the storage medium and the additional program is loaded at steps S1200 and S1210.

After completing to reproduce the multimedia contents stored in the main memory, the power control mode can be continuously performed or stopped according to operations of programs performed in the computer at step S1220.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to effect such feature, structure, or characteristic in connection with other ones of the embodiments. Furthermore, for ease of understanding, certain method procedures may have been delineated as separate procedures; however, these separately delineated procedures should not be construed as necessarily order dependent in their performance. That is, some procedures may be able to be performed in an alternative ordering, simultaneously, etc.

As described above, embodiments of methods and apparatus for reproducing multimedia contents have various advantages. For example, embodiments can increase efficiency of using electric power by interrupting to drive the storage medium during reproducing the multimedia contents. Also, embodiments can reduce or eliminate noise generated from the storage medium during reproducing the multimedia contents. In addition, embodiments can reduce heat generated during reproducing multimedia contents. Therefore, the user can concentrate to enjoy listening music or watching moving pictures reproduced from the multimedia contents.

The foregoing embodiments and advantages are merely exemplary and are not to be construed as limiting the present invention. The present teaching can be readily applied to other types of apparatuses. The description of the present invention is intended to be illustrative, and not to limit the scope of the claims. Many alternatives, modifications, and variations will be apparent to those skilled in the art. In the claims, means-plus-function clauses are intended to cover the structures described herein as performing the recited function and not only structural equivalents but also equivalent structures.

1. An apparatus for executing a content reproducing program in a computer, the apparatus comprising:
a storage medium configured to store a plurality of first contents;
a main memory configured to temporally store a second content selected from the first contents by a predetermined condition; and
a controller configured to selectively interrupt electric power to the storage medium during reproduction of the second content stored in the main memory.

2. The apparatus of claim 1, wherein the controller selectively interrupts the electric power of the storage medium by determining whether electric power is supplied from an external power source to the computer.

3. The apparatus of claim 1, wherein the controller interrupts the electric power of the storage medium when a power control mode for the contents reproducing program has been enabled.

4. The apparatus of claim 1, wherein the controller interrupts the electric power supplied to the storage medium when a window of the contents reproducing program substantially occupies a display screen.

5. The apparatus of claim 1, wherein the second content stored in the storage medium is divided into a plurality of divided contents to have a predetermined size when a size of the second content is larger than a capacity of the main memory, and wherein the divided contents are sequentially stored and reproduced in the main memory.

6. The apparatus of claim 5, wherein the electric power is re-supplied to the storage medium for storing next divided contents in the main memory according to an order of reproducing the second content stored in the storage medium when reproducing current divided contents stored in the main memory is completed, and wherein the electric power supplied to the storage medium is interrupted at least one time during reproduction of each divided contents stored in the main memory.

7. The apparatus of claim 6, wherein the electric power is re-supplied to the storage medium for storing the next divided contents in the main memory according to the order of reproducing the second content stored in the storage medium when a remaining time for reproducing the divided contents stored in the main memory or a remaining size of the divided contents stored in the main memory is less than a predetermined value.

8. The apparatus of claim 1, wherein the controller interrupts the electric power supplied to the storage medium at least one time during reproducing the second content stored in the main memory.

9. The apparatus of claim 1, wherein the controller is a video controller to be controlled by programmed input and output pin, wherein the first contents are multimedia contents including audio and video data, and wherein the storage medium is a hard disk, an optical disk or a memory card.

10. The apparatus of claim 1, wherein the controller determines to drive the storage medium according to a remained time of reproducing the second content stored in the main memory or a remained size of the second content stored in the main memory.

11. A method for operating a portable computer, the method comprising:
executing a contents reproducing program according to a request from a user;
selecting one of contents stored in a storage medium;
storing the selected content in a main memory;
reproducing the selected content stored in the main memory; and
interrupting electric power supplied to the storage medium.

12. The method of claim 11, wherein the interrupting is a result of at least one member chosen from a power mode setting, a battery mode determination or an on screen display characteristic of the contents reproducing program, and wherein the electric power supplied to the storage medium is interrupted at least one time during said reproducing the selected content stored in the main memory.

13. The method of claim 11, wherein the selected content stored in the storage medium are divided into a plurality of divided contents, and wherein the divided contents are sequentially stored in the main memory and reproduced according to an order of reproducing the contents.

14. The method of claim 11, wherein the electric power is re-supplied to the storage medium for storing next divided contents according to the order of reproducing the contents stored in the storage medium when a remaining time for reproducing the divided contents stored in the main memory or a remaining size of the divided contents stored in the main memory is less than a predetermined value, and wherein the electric power supplied to the storage medium is interrupted at least one time during reproducing the selected content stored in the main memory.

15. The method of claim 11, further comprising supplying electric power to the storage medium when the user requests to perform an operation requiring to drive the storage medium.

16. A method, comprising:
executing a con tents reproducing program to reproduce selected contents stored in a storage medium; and
determining to perform a power control mode for the contents reproduction program responsive to a predetermined condition, wherein the power control mode interrupts the power supplied to the storage medium when the selected contents are being reproduced.

17. The method of claim 16, wherein the power is interrupted for the storage medium for at least portion of the time the contents are being reproduced by the contents reproducing program.

18. The method of claim 16, wherein the selected contents are copied in a main memory and reproduced from the main memory when interrupting the power supplied to the storage medium.

19. The method of claim 16, wherein the predetermined condition is user selection, whether electric power is supplied from an external power source, or whether a user interface of the contents reproducing program substantially occupies an entire screen of a display device.

20. The method of claim 16, wherein during performing the power control mode, the selected contents stored in the storage medium are divided into a plurality of divided contents to have a predetermined size when a size of the selected contents is larger than a capacity of the main memory, wherein the divided contents are orderly stored in the main memory and reproduced according to a sequence for reproducing the selected contents, and wherein the power is re-supplied to the storage medium for storing next divided contents in the main memory according to the sequence of reproducing the selected contents stored in the storage medium when reproducing current divided contents stored in the main memory is completed.
